(19) United States
(12) Patent Application Publication
(10) Pub. No.: US 2025/0346258 A1
(43) Pub. Date: Nov. 13, 2025

(54) SYSTEM AND METHOD FOR INDEPENDENT SAFETY CONTROL

(71) Applicant: Cybernet Systems Corporation, Ann Arbor, MI (US)

(72) Inventors: Charles J. Jacobus, Brighton, MI (US); Glenn J. Beach, Grass Lake, MI (US); Charles J. Cohen, Ann Arbor, MI (US)

(21) Appl. No.: 18/661,113

(22) Filed: May 10, 2024

(51) Int. Cl. B60W 60/00; B60W 50/00; B60W 50/02; B60W 50/04

(52) U.S. Cl. CPC B60W 60/00186; B60W 50/0097; B60W 50/0205; B60W 50/04; B60W 2050/0215; B60W 2420/00; B60W 2556/50

(57) ABSTRACT

A system including a safety system communicatively coupled to at least a controller area network (CAN bus) and a vehicle driving control system. The vehicle driving control system controls at least direction and speed of a vehicle via the CAN bus. The safety system is configured to identify an unsafe driving condition and override at least one driving input that originates from one of a driver and an autonomous vehicle (AV) driving system when the unsafe driving condition is identified. The safety system is further configured to provide at least one new input to the driving control system after the unsafe driving condition is identified. The at least one new input causes the driving control system to change at least direction and/or the speed of the vehicle.

### TECHNICAL FIELD

The present disclosure generally relates to an independent vehicle safing (making a vehicle safe) system.

### BACKGROUND

An autonomous vehicle (AV) or a manual vehicle (MV) may include a vehicle safing system incorporated therein. For example, an AV may include an automated driving system having a safing system built therein. The system may include a plurality of sensors, computer hardware assets, and software assets employed to assess the driving environment and detect unsafe situations. If an unsafe driving situation is detected by the automated driving system, the AV may constrain operations within a safe driving envelope. For example, the AV may slow down, stop, or implement avoidance steering if an unsafe driving situation is detected. Similarly, a manual assistive drive system may be employed in a MV. As such, though a MV is driven under the control of the operator, a manual assistive drive system may take over vehicle control from the operator to constrain operations within a safe driving envelope.

Existing safing systems, whether employed in an AV or an MV, can be quite complex. Further, in addition to the complexity of existing safety systems, it can be difficult and/or costly to validate such systems. Often, an AV system or a manual assistive drive system is “custom” built for a particular make and model of a vehicle. Accordingly, the safing system employed, whether integrated into an AV system or designed as a manual assistive drive system, is generally validated for the particular make and model in which it was custom built. As such, if a manufacturer would like to employ a safing system for another make and model, the manufacturer generally custom builds another safing system, which in turn is validated for this other make and model. Accordingly, the custom nature of these safing systems and the accompanying need to revalidate such systems can be costly.

There is a need, therefore, for a safing system that can be employed on a variety of vehicles without the need to redesign and revalidate the safing system for each vehicle.

### BRIEF DESCRIPTION OF THE DRAWINGS

FIG. 1A is a block diagram of an exemplary vehicle architecture having an exemplary independent safety system incorporated therein;

FIG. 1B is a block diagram of the exemplary safing system of FIG. 1A;

FIG. 2A illustrates an exemplary technique for enhancing vehicle safety; and

FIG. 2B illustrates an exemplary technique for identifying an unsafe driving condition.

### DETAILED DESCRIPTION

Referring to the discussion that follows and the Figures, illustrative approaches to the disclosed systems and methods are described in detail. Although the Figures represent some possible approaches, the Figures are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the Figures and disclosed in the following detailed description.

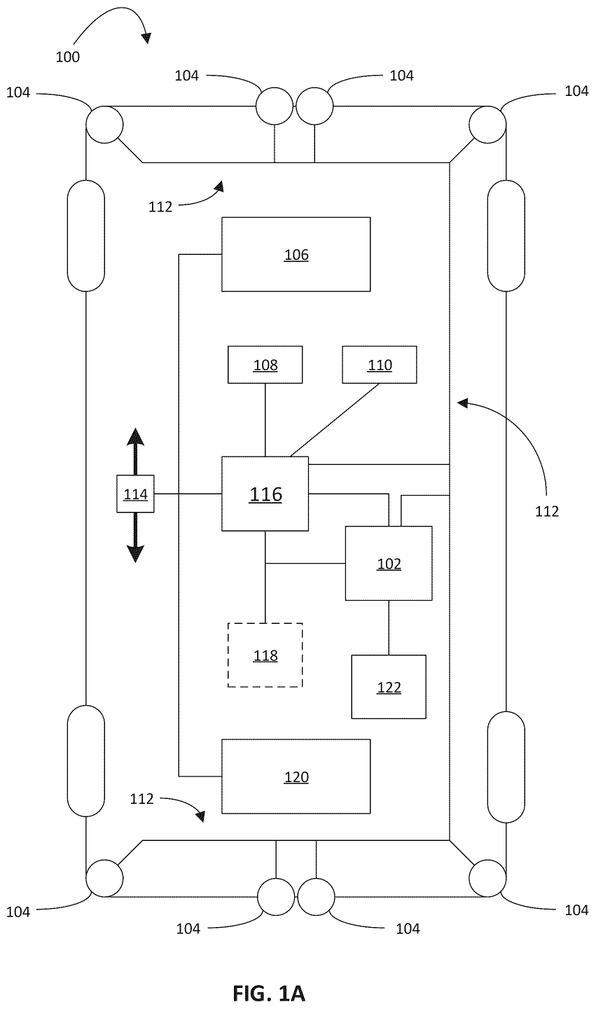

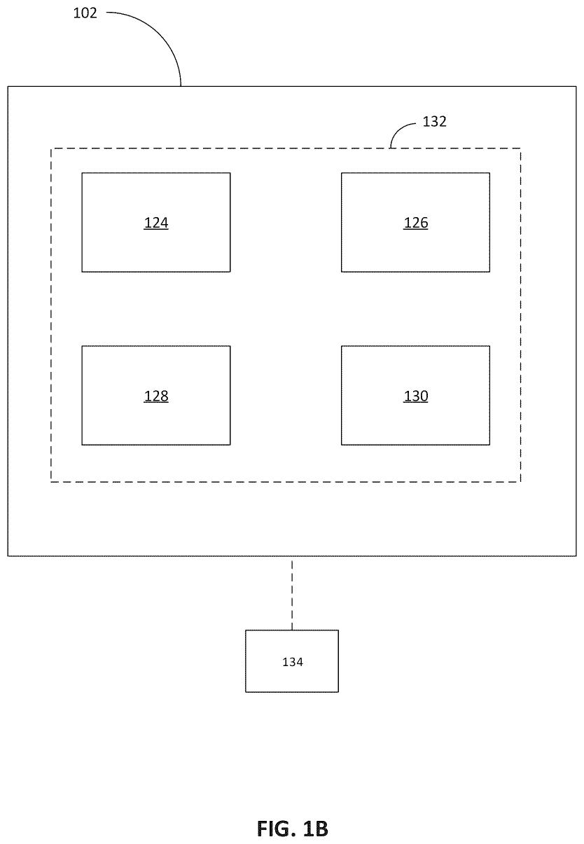

With reference now to FIG. 1A, a block diagram of an exemplary vehicle 100 having an exemplary independent autonomous safety system (IAVSS) 102 (a.k.a. a safing system or safety system) incorporated therein is shown. The vehicle 100 includes a plurality of sensors 104 for tracking vehicle location and/or obstacle detection. These sensors 104 may include, for example, some combination of video, range, inertial measurement units (IMUs), and/or inertial navigation sensors (INSs). Further, such sensors may include, for example, light detection and ranging (LIDAR) sensors, radar sensors, and/or 3D stereo wide sensors to name a few. Any sensor that gather details about the environment in which the vehicle 100 operates is contemplated.

The vehicle 100 also includes a steering control module 106, dashboard host control interface (HCI) 108, one or more vehicle to vehicle (V2V), vehicle to infrastructure (V2I), and vehicle to pedestrian (V2P) transceivers 110, a sensor bus 112, a controller area network (CAN) bus 114, and controller 116. If the vehicle 100 is an autonomous vehicle (AV), the controller 116 may then be an AV controller. Alternatively, if the vehicle 100 is a manual vehicle (MV), the controller 116 would be a MV controller, which may or may not be coupled to an assistive drive system.

The controller 116 is in communication with the sensors 104 via the sensor bus 112. Further, the controller 116 is communicatively coupled to the CAN bus 114, which in turn is in communication with microcontrollers and/or other devices for controlling the vehicle. Still further, the controller 116 may be communicatively coupled to a self-location subsystem 118 if the vehicle 100 is an AV.

Also shown in the vehicle 100 are speed, brake, acceleration, and transmission control system 120.

The IAVSS 102 is communicatively coupled to an emergency stop system 122, the controller 116, the sensors 104, and the self-location subsystem 118 (if there is one). The IAVSS 102 may be comprised of a software stack and/or one or more hardware modules. The IAVSS 102 operates independently from vehicle planning systems (if any) and other control systems. For example, the IAVSS 102 is independent from the controller 116. As such, the IAVSS 102 is not incorporated into the controller 116, but rather is independent from, and operates in parallel to, the controller 116. Since the IAVSS 102 operates in parallel to the controller 116, the IAVSS 102 may more easily be incorporated into a vehicle. That is, it may be configured to work with already existing controllers from other vehicles (not shown), whether it is an AV or MV.

The IAVSS 102 is configured to override any driver or autonomous system if an unsafe driving condition is identified. Further, once the IAVSS 102 identifies an unsafe driving condition, the IAVSS 102 initiates mitigation behavior. The mitigation behavior may include, for example, vehicle stopping and/or shutdown, starting and moving, steering away and/or around obstacles, signaling a breakdown, calling for help, accelerating to avoid and unsafe condition, communicating with infrastructure systems (e.g., emergency services), and/or slowing to safe speeds due to weather, traffic and/or obstacles. Other mitigation behaviors are contemplated.

Effectively, the IAVSS 102 operates as a “safe sensor.” If the vehicle is an AV, and the IAVSS 102 identifies or senses an unsafe driving condition, the IAVSS 102 injects a “safety assessment” message into the AV suite to initiate mitigation behavior. Similarly, if the vehicle is an MV, and the IAVSS 102 identifies or senses an unsafe driving condition, the IAVSS 102 injects a “safety assessment” message into an MV control system or assistive drive system (e.g., an advanced driver assistive systems (ADS)) to initiate mitigation behavior. For example, the safety assessment message may ensure a driver does not disobey traffic laws (e.g., take the vehicle to speeds above posted speed limits).

With reference now to FIG. 1B, an exemplary block diagram of the IAVSS 102 is shown. The IAVSS 102 includes a world model 124, a localization module 126, and a safety aggregator module 128.

Referring to FIGS. 1A and 1B, The world model 124 receives data (a.k.a. sensor output) from one or more of the plurality of sensors 104 to at least create a model of obstacles and terrain the vehicles is, or will be, encountering. One or more of these sensors 104 may also provide data regarding details identified in traffic control systems (e.g., the state of traffic lights, traffic flow state set forth in signage, and/or yield and speed limit rules set forth in signage).

The world model 124 also receives driving inputs. These inputs may include, for example, driver command inputs (e.g., turning, braking, and/or accelerating) if the vehicle is an MV. Alternatively, the inputs may include AV driving command inputs from an AV suite if the vehicle is an AV. Effectively, the world model module 124 fuses sensor data and driving inputs to create a world model that details the driving environment including obstacles and terrain around the vehicle 100.

Whether the vehicle is an AV or a MV, the world model 124 helps ensure that the driving inputs/commands do not cause the vehicle to disobey traffic laws (e.g., speed limits) and/or implement an unsafe driving condition (e.g., entering a prohibited area or a space already occupied by a vehicle or other obstacle).

With the information gathered via the world model 124, the IAVSS 102 may continuously do the following: assess the health of AV hardware if implemented (e.g., controller 116), other controls, and applicable software; assess the position and velocity of the vehicle 100 in relation to the terrain and objects (e.g., vehicles, pedestrian(s), barriers, debris, and etc.) along the driving path; help predict potential collisions or unsafe driving events/conditions in the driving path; carry out proximity checking of objects close to the vehicle within predetermined safety zones around the vehicle in the direction of travel; verification that the vehicle is, and is planning to, operate in safely traversable area (in contrast to in areas denied by safety concerns or traffic rules consistent with vehicle operating rules); and check for system wide commanded slowdowns and/or stops (i.e., commands from a central traffic manager to stop and/or slowdown). If the vehicle is an MV, the IAVSS 102 may also check for manually directed emergency stops while also modeling vehicle environment in light of driving inputs.

As mentioned above, the IAVSS 102 also includes the localization module 126 that provides information to the world model 124. Generally, the localization module 126 determines vehicle location, speed, acceleration, and/or direction of travel. It is noted that the localization module 126 of the IAVSS 102 is distinct from a localization module or subsystem 118 that may be included in an AV or MV.

The localization module 126 of the IAVSS 102 can make localization determinations through a variety of techniques and combinations thereof. For example, the localization module 126 may rely on vehicle position data from a global positioning system (GPS) provided by a variety of countries and companies worldwide. One or more of the exemplary sensors 104 may include a GPS unit that gathers position data from a GPS to provide location information to the localization module 126.

One or more INSs and/or IMUs may also be employed in conjunction with the with the GPS to provide, for example, location, acceleration, speed, and direction information to the localization module 126. Often, an INS system and/or IMU system may be used in conjunction with a GPS system to obtain a more accurate measurement of vehicle location along with a more accurate measurement of speed, acceleration, and direction. While the terms “speed” and “acceleration” may be used colloquially herein, it is understood technical terms such as “velocity” and “acceleration” are vectors and, therefore, inherently include direction information therein.

In yet another example, one or more of the sensors 104 may be employed to determine wheel revolutions to measure turn angle, speed, distance traveled, and/or etc., which in turn is provided to the localization module 126. In other words, odometry techniques may also be employed to determine turn angle, speed, distance traveled, direction, and etc.

In still yet another example, the localization module 126 may rely on landmark sightings to determine vehicle location, direction and etc. For example, a database 130 (or other memory) that is accessible by the location module 126 may include detailed information of landmarks (e.g., location information of mountains and/or other physical terrain characteristics, buildings, road signs, stop lights, intersections, warehouse markers and/or structural elements, and etc.). A landmark may be identified via one or more of the sensors 104. As such, the landmark location information in the database 130 may be employed to determine the vehicle's location. Such a technique may, for example, be helpful to determine vehicle location when GPS information is not available (e.g., when GPS signal is blocked or when a GPS unit is defective).

Several localization techniques are described above, but it is understood that the localization module 126 may rely on other localization techniques not discussed.

With continued reference to FIG. 1B, and as mentioned above, the IAVSS 102 includes a safety aggregator (SA) module 128 in addition to the localization module 126 and the world module 124. The SA module 128 identifies unsafe driving conditions. As such, the SA module may identify sources of failure or potential failure. For example, the SA module 128 may identify failure of hardware systems (e.g., sensors or other hardware systems), failure of software modules implementing vehicle autonomy and/or sensor operation, and failure of internal diagnostics performed by vehicle equipment (e.g., sensors, engine controls, transmission controls, various control actuators, steering, braking, acceleration, and/or etc.).

The SA module 128 may identify the failure or potential failure based on internal assessments. As discussed above, the world model module 124 fuses sensor 104 data to continually update a model of the vehicle in its surroundings. The world model module 124 may compare outputs from various sensors to measure sensor error. If the world model module 124 identifies a sufficient error (i.e., an error greater than a predefined threshold or an error that may result in an unsafe driving condition) associated with a sensor, the world model module 124 may be configured to provide a fault condition to the SA module 128. In turn, the SA module 128 may ensure that data from faulty sensor is locked out of the world model module 124. As such, the world model module 124 may not employ the faulty sensor data in the sensor data fusion process employed to create the world model.

Further, if the SA module 128 determines that that enough sensor data is faulty (or missing), the SA module may provide a notification to a user and/or provide commands to the controller 116 to initiate safing actions (e.g., slowing the vehicle or stopping the vehicle).

The SA module 128 may also be configured to receive fault notifications. That is, the SA module 128 may receive fault notifications from hardware modules and sensors (e.g., one or more of the sensors 104 of FIG. 1A) that incorporate their own fault detection systems. If, based on received fault notification(s), the SA module 128 identifies an unsafe driving condition, the SA module 128 may control the vehicle via commands sent to the controller 116 and/or simply notify the operator or user of the vehicle 100.

Further, the SA module 128 may identify vehicle commands that will or may result in some type of unsafe driving condition. For example, if an operator initiates a command to emergency stop (E-Stop), the SA module 128 may determine if such an E-stop command initiated by the driver will or may result in an unsafe driving condition. Further, the SA module 128 may determine or identify unsafe driving speeds and a dangerous vehicle location relative to fixed and/or moving objects in the environment.

With reference to both FIGS. 1A and 1B, it is again noted that the IAVSS 102 is connected in parallel to the vehicle controller 116 (whether it is an MV controller, an AV controller, or some combination of both) and it may have access to one or more of the sensors 104. In another example, the IAVSS 102 may be part of a system that employs its own sensors (not shown) and it may employ those sensors or some combination of its own sensors and vehicle sensors 104 to identify system, vehicle, and/or driver failures. In either case, the IAVSS 102 is operated in parallel to the operating systems (e.g., the controller 116) of the vehicle 100.

Regardless of the sensors employed, since the IAVSS 102 sits in parallel to the vehicle controller 116, the IAVSS 102 (e.g., via the SA module 128) is able to take control of the vehicle 100 via the CAN bus 114 if a safety violation or other unsafe driving condition is identified via the SA module 128. The unsafe driving condition may, for example, be the result of an internal vehicle systems failure and/or a pending unsafe driving event (e.g., a potential collision due to leaving an authorized driving area such as entering an intersection incorrectly, heading for a potential collision, and/or changing lanes incorrectly).

The IAVSS 102 and its accompanying SA module 128 implements a level autonomy to effect safety responses, while the controller (MV or AV) 116 implements driving functions.

It is noted that the techniques and acts of the IAVSS 102 may be incorporated into one or more computer readable storage mediums 132, which may be carried out via one or more processors 134. That is, instructions employed to carry out acts of the IAVSS 102 may be stored on the one or more storage mediums 132. Alternatively, a hardware/software implementation may be carried out such that one or more processors 134 and software module(s) are built up to carry out the actions of the IAVSS 102.

Still further, in some examples, the IAVSS 102 could be incorporated into a vehicle controller (e.g., the controller 116 of FIG. 1A) or an AV suite that may be employed. In any of the examples, the IAVSS 102 operates in parallel to any existing controller system so that the IAVSS 102 serves as the arbitrator of safety.

The IAVSS 102 discussed above may be deployed in a variety of vehicles. For example, the vehicle 100 may be a construction vehicle, airport support vehicle, material handling vehicle, and/or a military vehicle-to name a few. Since the IAVSS 102 operates in parallel to any existing AV system, revalidation of the safing system may not be needed. Further, since the IAVSS 102 operates in parallel to any existing AV system, it may be added at a later date.

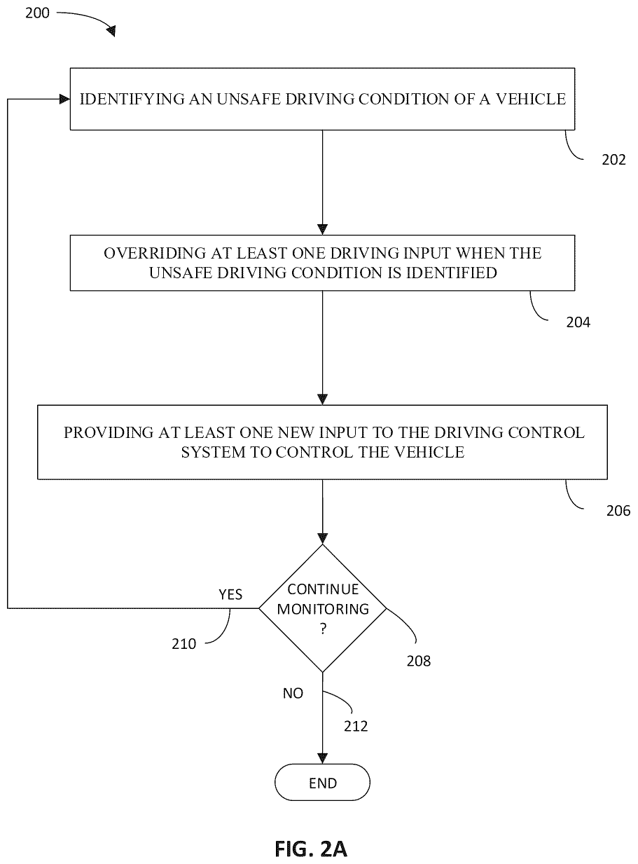

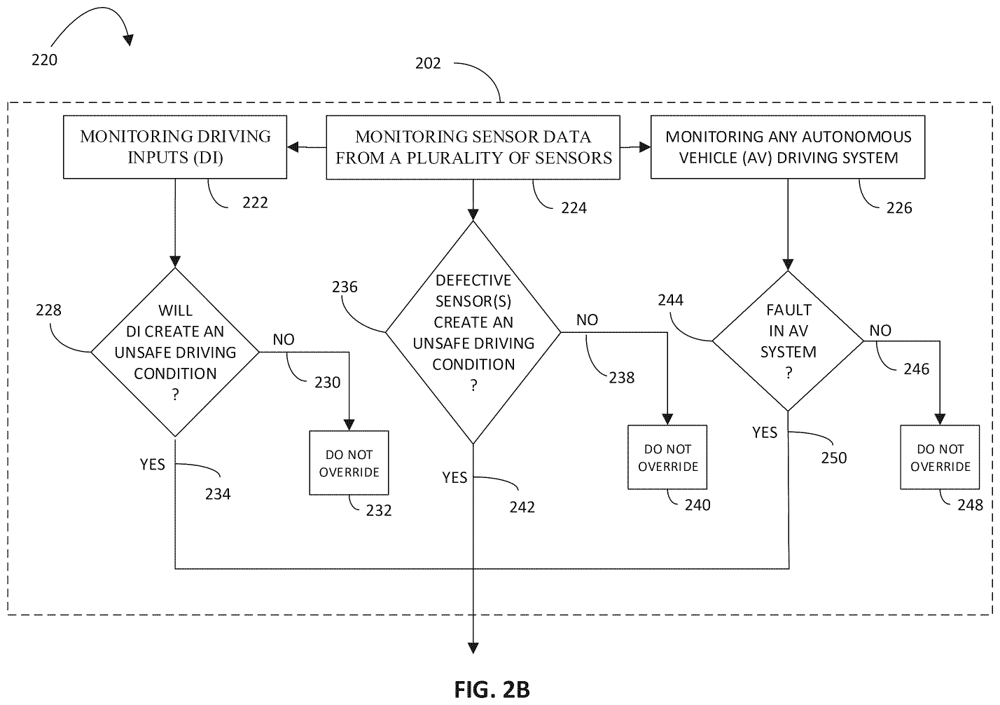

Referring now to FIG. 2A, an exemplary technique 200 for enhancing vehicle safety is shown. Process control begins at block 202, where identifying an unsafe driving condition of a vehicle is carried out. As discussed above with respect to FIGS. 1A-1B, there may be a variety of events that may cause an unsafe driving condition. For example, malfunction(s) in an autonomous driving system, errors made by a driver, incorrect sensor data or lack thereof, and/or threats imposed by driving terrain or other objects (e.g., other vehicles and/or animals) serve as just a few examples of what can cause an unsafe driving condition. The exemplary IAVSS 102 of FIGS. 1A and 1B may be employed to identify the unsafe driving condition(s).

With continued reference to the technique of FIG. 2A, after identification of the unsafe driving condition, process control proceeds to block 204, where overriding at least one driving input when the unsafe driving condition is identified is carried out. The driving input(s), whether they come from a driver or an AV system, are intended to be provide to a driving control system to controls the vehicle. Process control overrides the driving input(s) at block 204 and, as such, prevents the driving inputs from controlling the vehicle.

After the driving input(s) are overridden, or while the driving input(s) are being overridden, process control carries out providing at least one new input (a.k.a. new driving input(s)) to the driving control system to control the vehicle at block 206. The at least one new input causes the driving control system to change at least one of the direction and the speed of the vehicle to remove or mitigate the unsafe driving condition. The new input may be provided to the driving control system via, for example, a controller area network (CAN bus) that allows communications between microcontrollers.

Technique 200 continues at decision block 208, where it is determined whether or not to continue the autonomous safety monitoring technique 200. If the technique is continued 210, process control proceeds to block 202 as identification of unsafe driving conditions continues.

If, on the other hand, it is determined not to continue 212 identifying unsafe driving conditions, process control proceeds to an END. One example of such a decision could simply be the vehicle being turned off.

The identification of unsafe driving conditions 202 in the exemplary technique 200 of FIG. 2A may be carried in a variety of ways. For example, FIG. 2B illustrates an exemplary technique 220 for identifying unsafe driving conditions 202.

The exemplary technique 220 includes monitoring driving inputs at block 222, monitoring sensor data from a plurality of sensors at block 224, and monitoring any AV driving system or assistive driving system the vehicle may employ at block 226. In some instances, the vehicle may not include an AV driving system or an assistive driving system. As such, techniques for identifying unsafe driving conditions need not employ the monitoring set forth in block 226.

Nonetheless, while monitoring the driving inputs at block 222, process control determines whether any of the driving inputs will create an unsafe driving condition at block 228.

If the driving inputs will not create 230 an unsafe driving condition, process control proceeds to block 232 and the driving input(s) are not overridden. Alternatively, if the driving input(s) will create 234 an unsafe driving condition, the driving input(s) are overridden (see block 204, FIG. 2B). For example, an IAVSS module may determine that, based on the sensor inputs 224, one or more driving inputs may cause a vehicle to be set on a collision course with another vehicle or object. In such an instance, process control causes at least some driving input(s) (e.g., steering, acceleration, and/or braking) to be overridden.

As mentioned above, the exemplary technique 220 for identifying an unsafe driving condition also includes monitoring sensor data from a plurality of sensors (e.g., one or more of the sensors 104 of FIG. 1) at block 224. At block 236, process control determines if any of the sensors are defective and, if so, if the defective sensor(s) will produce an unsafe driving condition. That is, if there is one or more defective sensors, the technique 220 determines if the defective sensor may create an unsafe driving condition. An IAVSS may determine if a sensor is defective. Additionally, the sensor may have its own system to determine if it is defective, in which case the sensor system(s) would notify the IAVSS it is defective.

If it is determined that the defective sensor(s) would not create 238 an unsafe driving condition, process control proceeds to block 240 and the driving inputs are not overridden. For example, one or more sensors may be producing minor senor errors that do not impact the driving safety of the vehicle.

On the other hand, it may be determined that one or more defective sensors do impact 242 the driving safety of the vehicle. In such a scenario, process control may cause at least some of the current driving inputs to be overridden (see, e.g., block 204 of FIG. 2A). For example, if the vehicle is an AV vehicle, and it is determined one or more defective sensors could cause an unsafe driving condition, the IAVSS may override the AV system and safely bring the vehicle to stop.

As also mentioned above, in addition to monitoring driving inputs 222 and sensor data 224, the technique 220 of FIG. 2B also includes monitoring any AV driving system that may exist at block 226. The AV driving system may include an AV suite including hardware and/or software. Effectively, the components that control the autonomous driving of the AV vehicle are monitored.

While monitoring the AV drive system, process control proceeds to block 244 where it is determined whether or not the AV driving system has a fault. Sensor data 224 may be employed to make the determination at block 244. If the AV Drive system does not 246 have a fault, process control proceeds to block 248 and driving inputs are not overridden.

Alternatively, if it is determined that the AV driving system has a fault 250, at least one driving input may be overridden (e.g., block 202 of FIG. 2A). An IAVSS may, for example, be monitoring the AV drive system and determine that the AV drive system's world model module and/or localization module is producing errors. As such, the IAVSS may determine that the AV drive system includes a fault, thus causing any drive inputs from the AV system to be overridden.

It is noted that a world model module and localization module of an AV system is distinct from a world model module (e.g., the world model module 124 of FIG. 1A) and localization module (e.g., the localization module 126 of FIG. 1A) of an IAVSS (e.g., IAVSS 102, FIG. 1A). As discussed above, with regard to an AV, the IAVSS operates in parallel to the AV driving suite. Accordingly, the IAVSS serves as the arbiter of safety.

With regard to the processes, techniques, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain examples, and should in no way be construed so as to limit the claims.

Further, when introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Next, any numerical examples in the following discussion are intended to be non-limiting, and thus additional numerical values, ranges, and percentages are within the scope of the disclosed embodiments. Still further, the use of terms such as “first,” “second,” “third,” and the like that immediately precede an element(s) do not necessarily indicate sequence unless set forth otherwise, either explicitly or inferred through context.

While the preceding discussion is generally provided in the context of a material used in connection with vehicles, it should be appreciated that the present techniques are not limited to such limited contexts. The provision of examples and explanations in such a context is to facilitate explanation by providing instances of implementations and applications. The disclosed approaches may also be utilized in other contexts or configurations, such as the context of other systems that employ an internal combustion engine that may not be a vehicle.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. As system comprising:
a safety system communicatively coupled to at least a controller area network bus (CAN bus) and a vehicle driving control system, the CAN bus allows a plurality of microcontrollers to communicate therebetween and the vehicle driving control system controls at least direction and speed of a vehicle via the CAN bus, wherein the safety system is configured to:
identify an unsafe driving condition of the vehicle;
override at least one driving input that originates from one of a driver and an autonomous driving system when the unsafe driving condition is identified, wherein the at least one driving input was intended to be provided to the driving control system to control the vehicle; and
provide at least one new input to the driving control system to control the vehicle, wherein the at least one new input causes the driving control system to change at least one of the direction and the speed of the vehicle.

2. The system of claim 1 wherein the safety system comprises a localization module configured to receive sensor input from a plurality of sensors of the vehicle to determine a location of the vehicle.

3. The system of claim 2 wherein the localization module is distinct from an autonomous vehicle (AV) localization module.

4. The system of claim 3 wherein the safety system further comprises a safety aggregator (SA) module configured to:
carry out the identification of the unsafe driving condition of the vehicle, wherein the unsafe driving condition is based on a failure of at least one sensor of the plurality of sensors; and
cause the at least one driving input to be overridden based upon the identification of the unsafe driving condition.

5. The system of claim 2 wherein the safety system further comprises a world model module configured to:
receive the location of the vehicle from the localization module;
receive sensor data from at least some of the plurality of sensors;
determine vehicle proximity to objects around the vehicle based on the location and the sensor data;
receive driving commands; and
predict future paths of the vehicle based at least in part on the driving commands, the sensor data, and the vehicle proximity to the objects around the vehicle.

6. The system of claim 4 wherein the SA module is further configured to identify failure of at least one software module implementing vehicle autonomy.

7. The system of claim 4 wherein the SA module is further configured to receive data from the plurality of sensors to identify the unsafe driving condition.

8. The system of claim 4 wherein the plurality of sensors includes at least a first sensor and a second sensor, and wherein the safety system is further configured to compare inputs from the first sensor to inputs from at least the second sensor to determine whether one of the plurality of sensors is malfunctioning.

9. An apparatus comprising:
at least one computer readable storage medium couplable to a vehicle, the at least one computer readable storage medium having instructions stored thereon to:
gather sensor data from a plurality of sensors, wherein at least one sensor of the plurality of sensors is configured to receive input regarding an outside environment in which the vehicle is operating;
identify an unsafe driving condition of the vehicle, wherein identification of the unsafe driving condition is based at least in part on the vehicle sensor data;
override at least one driving input that originates from one of a driver and an autonomous vehicle (AV) driving system when the unsafe driving condition is identified, wherein the at least one driving input was intended to be provided to a driving control system to control the vehicle; and
provide at least one new input to the driving control system to control the vehicle after the unsafe driving condition is identified, wherein the at least one new input causes the driving control system to change at least one of the direction and the speed of the vehicle.

10. The apparatus of claim 9, the at least one computer readable storage medium having further instructions stored thereon to determine a location of the vehicle via at least one sensor of the plurality of sensors.

11. The apparatus of claim 10, the at least one computer readable storage medium having further instructions stored thereon to:
determine vehicle proximity to objects around the vehicle based on the location and the sensor data;
receive driving commands from at least one of a driver and the AV driving system, wherein the driving commands includes the at least one driving input; and
predict future paths of the vehicle based at least in part on the driving commands, the sensor data, and the vehicle proximity to the objects around the vehicle.

12. The apparatus of claim 11, the at least one computer readable storage medium having further instructions stored thereon to identify a failure of at least one software module controlling the AV driving system, wherein the failure of the at least one software module controlling the AV driving system creates the unsafe driving condition.

13. The apparatus of claim 9, wherein the plurality of sensors includes at least a first sensor and a second sensor, the at least one computer readable storage medium having further instructions stored thereon to compare inputs from the first sensor to inputs from at least the second sensor to determine whether one of the plurality of sensors is malfunctioning.

14. A method comprising:
identifying, in part via at least one processor, an unsafe driving condition of the vehicle;
overriding, in part via the at least one processor, at least one driving input that originates from one of a driver and an autonomous vehicle (AV) driving system when the unsafe driving condition is identified, wherein the at least one driving input was intended to be provided to the driving control system to control the vehicle; and
providing, via a controller area network bus (CAN bus), at least one new input to the driving control system to control the vehicle, wherein the at least one new input causes the driving control system to change at least one of the direction and the speed of the vehicle.

15. The method of claim 14 further comprising receiving sensor output from a plurality of sensors of the vehicle, wherein the sensor input represents a driving environment around the vehicle.

16. The method of claim 16 further comprising determining a localization of the vehicle based at least in part on the sensor output, wherein the localization includes proximity of the vehicle to one or more other objects in the driving environment, and wherein the determination of the localization is independent from a localization determination carried out by an autonomous vehicle drive system.

17. The method of claim 16 wherein identifying the unsafe driving condition includes receiving the at least one driving input from the AV driving system, wherein identifying the unsafe driving condition is based in part on the at least one driving input.

18. The method of claim 16 further comprising comparing a first sensor output to at least a second sensor output to determine if one of a first sensor and a second sensor is defective, wherein the first and second sensors are part of the plurality of sensors.

19. The method of claim 17 further comprising:
monitoring the AV driving system; and
determining if the AV driving system is faulty.

20. The method of claim 15 further comprising predicting a potential future path of the vehicle based in part on the sensor output and the at least one driving input.
